(19) United States
(12) Patent Application Publication
(10) Pub. No.: US 2017/0060378 A1
(43) Pub. Date: Mar. 2, 2017

(54) ACCELERATED PANNING OF LARGE USER INTERFACE OBJECTS

(71) Applicant: Peri Hartman, Seattle, WA (US)

(72) Inventor: Peri Hartman, Seattle, WA (US)

(21) Appl. No.: 15/246,183

(22) Filed: Aug. 24, 2016

Related U.S. Application Data
(60) Provisional application No. 62/209,165, filed on Aug. 24, 2015.

(51) Int. Cl. G06F 3/0481; G06F 3/0486; G06F 3/0488; G06F 3/0485

(52) U.S. Cl. CPC G06F 3/04812; G06F 3/04855; G06F 3/0486; G06F 3/0488; G06F 2203/04803

(57) ABSTRACT

When an object is too large to display within a given space, the “accelerated panning” method provides a method for the user to pan the object in order to view other areas of the object. The user begins the pan operation by touching the display over the object and dragging the finger; the object pans synchronously with the finger movement. When the user drags into a margin area within the perimeter of the receiving object, the object panning rate will increase. The direction of the pan corresponds to the particular margin. For example, if the user drags into the top margin, the contents of the object will scroll downward. In addition, the further the user moves into the margin, toward the edge of the object, the faster the panning. “Sequential value pickers” allows the user to pick a value from a set of sequential values.

### TECHNICAL FIELD

The present disclosure relates to apparatus, systems, methods and techniques that employ or implement user interfaces on touch enabled electronic devices, such as tablets or mobile phones, or other touch-enabled displays.

### DESCRIPTION OF THE RELATED ART

As used herein and in the clams, the term “representation” means a graphical representation of an object on a display (i.e., a virtual object, virtual element or icon). As used herein and in the claims, the term “drag operation”, means selecting an object representation, and dragging the object representation in a continuous move without releasing the selection, and ending the drag operation by releasing the section of the object representation. For example, when employing a touch-screen or touch-sensitive display, a drag operation can be implemented by touching a portion of the touch-screen or touch-sensitive display at a location where the object representation appears with a finger or stylus, and moving the finger or stylus to another location while maintaining contact with the touch-screen or touch-sensitive display and, finally, at some later point, removing the finger or stylus from contact with the touch-screen or touch-sensitive display to end the drag operation. Also for example, when employing a mouse or trackball, a drag operation can be implemented by positioning a cursor at a location where the object representation appears and activating (e.g., pressing or holding) a button or key on the mouse or trackball, then moving the cursor to another location while continually actuating the button or key, and finally, at some later point, deactivating (e.g., releasing) the button or key to end the drag operation. Thus, the various approaches described herein can be used with a finger on a touch-enabled display, but are not limited to such, and can be used with a stylus or even other pointing mechanisms, for instance a computer mouse or trackball to name a few.

As used herein and in the claims, the terms “letting up” or “lets up” mean, in the case of a touch-screen or touch-sensitive display, removing a finger or stylus from contact with the display. As used herein and in the claims, the terms “letting up” or “lets up” mean, in the case of a computer mouse or trackball, means deactivating, releasing or otherwise disengaging a button on the computer mouse or trackball. As used herein and in the claims, the term “fling” means to begin a drag operation but to let up while rapidly dragging the pointer (e.g., finger, stylus, cursor) on the display. As used herein and in the claims, the term “drag and drop” operations, which is used to move an object representation to another position on a display, means selecting the object representation via a pointer, dragging the object representation with the pointer along the display without deselecting (e.g., letting up) until the object representation is in a desired location, and then deselecting (e.g., letting up) the object representation. It is noted that the approaches described herein can be employed with any of a wide variety of computing devices, for example, mobile or smartphones, tablet computers, desktop computers, laptop computers, wearable computers, and embedded computers (e.g., in cars or appliances), and applies to both touch-enabled displays and non-touch-enabled displays.

When an object representation is too large to be displayed in its entirety within a given region on the display, various implementations provide a method or methods to view the desired region of the object representation. These methods include, for example, drag operations, fling operations, and the use of scroll bars.

With a drag operation, the object representation moves synchronously (i.e., the velocity that the object represent moves across the display matches the velocity at which a pointer moves) with, for example the user's finger while touching the display, and the object representation stops moving when the user lets up or releases. The term “panning” is used herein for this operation since the user can move the object representation in any direction while dragging, not just along one axis. We use the term scrolling for the special case of panning along one axis. The distance the object representation can move in any single direction in one drag operation is limited by the size of the display. For an object representation many times larger than the display, many drag operations would be required to pan the object representation from one extreme to the other. Another limitation is that a drag operation cannot be used simultaneously with a drag and drop operation. If the user desires to perform a drag and drop operation within a region that is larger than the display, the user will have to alternate two or more times between drag operations and drag and drop operations.

With a fling operation, the object representation moves synchronously with the user's finger while his finger is touching the display, just as we described for a drag operation. However, when the user lets up, the then current speed, or “terminal speed”, and the then current direction, or “terminal direction” (collectively velocity or “terminal velocity:, of the finger movement just before letting up are used to continue scrolling in that direction according to an algorithm. For example, one algorithm starts with the terminal velocity and decreases it linearly over time until it reaches zero. During that time, scrolling continues in the terminal direction with the scroll rate equal to the calculated velocity of the moment.

The fling operation allows panning from one region of a very large object representation to another quite efficiently compared to the drag operation, although it is limited to one direction at a time. However, the fling operation cannot be used in combination with a drag and drop operation.

A scroll bar typically is aligned vertically or horizontally with the display, but could conceivably be aligned along any axis of the display. The scroll bar is associated with an object representation. The length of the scroll bar represents the dimension of the associated object representation, including its non-displayed regions or portions, along the same axis as the respective scroll bar. The scroll bar also has an indicator representing the currently displayed region or portion of the associated object representation along the same axis as the scroll bar. If the user moves the indicator, the associated object representation will scroll proportionately. For example, if the indicator is moved from the top to the bottom of a vertical scroll bar, the associated object representation will scroll from one extreme to the other.

Scroll bars disadvantageously take up space on the display that could otherwise be used to display the principal objects or content. This is exacerbated on processor-based devices with small displays. Scroll bars disadvantageously allow panning along exactly one axis at a time. Thus to pan in some arbitrary direction, a user needs to alternately use two scroll bars which operate along different axes. Further, it is difficult to precisely position the final area to be viewed using scroll bars, since for large object representations, a small movement of the scroll bar will often cause a large movement of the object representation. This requires the user to perform an additional drag operation to precisely finish position the object representation. Another disadvantage is that a scroll bar cannot be used simultaneously with a drag and drop operation. If a user desires to perform a drag and drop operation within a region that is larger than the display, the user has to alternate two or more times between scroll bar operations and drag and drop operations.

A value picker allows a user to choose a specific value from a set of values. If this set of values is small, the values may be presented as a drop down list or other user interface structure where the user can see the whole list on a display or screen at a single time, and select value from the list. Examples of user interface structures suitable for presenting relatively small lists include: a list statically shown on a display, a set of radio buttons, or even a checkbox for a very small set of values (e.g., ON or OFF). A “sequential value picker” is a value picker where the values belong to a predictable sequence (e.g., consecutive integers, consecutive years).

If a set of values is too large to show statically on a display, then the set of values are typically shown in a scrollable list. For example, a set of colors ordered by light frequency, from near-infrared to near-ultraviolet may be presented as a scrollable list. Also for example, minutes in an hour (i.e., 0 through 59) or a set of temperatures may be presented as a scrollable list.

When the values in a set are sequential, such as in the examples above, there is no need to display the values in the list. Since the values belong to a sequence and are predictable, all that is needed is the scrolling action such that the value on the display changes synchronously with the degree of scrolling. This approach is commonly employed to, for example, implement time and date selectors, typically which have a “controller” region which appears to spin in response to user input. That is, by dragging in a given direction (e.g., down, up) in controller region, the selected value changes linearly with the dragging. By swiping or repeatedly dragging, a user can eventually scroll through a long set of possible values to the desired value.

For large sets of values (e.g., minutes in an hour) this can take several user operations to obtain the desired value. For example, a user might start by swiping to move through a large subset of values, followed by several drag operations to reach the desired value.

Improved approaches to implementing user interfaces for manipulation of object representations or virtual elements with relatively large dimensions (i.e., at least one dimension that is larger than a corresponding dimension of a display on which the object representation is presented) are desirable. Such approaches may make it possible to quickly and efficiently pan, scroll and/or to perform drag and drop operations using the relatively large object representations or virtual elements, for example allowing a user to perform various operations with a single user interaction (e.g., drag operation or interaction).

### SUMMARY

The present disclosure relates to apparatus, systems, methods and techniques for panning or scrolling large virtual objects (e.g., large relative to a viewable area) on displays, for example displays of touch enabled electronic devices, such as tablets or mobile phones, or other touch-enabled displays or touch-sensitive or touch-response screens.

Some of the approaches described herein are directed to methods executable on processor-based devices, for example mobile phones, tablet computers, or other processor-based devices that receive user input, for instance via touch enabled or touch sensitive displays, that allow a user to precisely pan or scroll an object representation or virtual object in one operation. Some of the described approaches also satisfy the need for a user to precisely perform a drag and drop operation in a region that is larger than a displayable region in one operation. Given an object representation (i.e., virtual object) and a displayable region to view that object representation, at least some of the approaches reserve a margin area or portion (i.e., margin) within a perimeter of the displayable region, distinct from a central portion. When the user drags in the central portion of the displayable region, not in the margin, the object representation pans or scrolls synchronously with movement of a pointer (e.g., cursor, stylus, finger). If the pointer is stationary, the object appears stationary. When the pointer is positioned in the margin, the object pans or scrolls at a higher rate than when the pointer is in the central portion. In some implementations, the higher rate may vary based on a position of the pointer in the margin relative to the central portion. For instance, the rate of movement (e.g., panning, scrolling) may increase as the pointer (e.g., cursor or finger) moves in the margin relatively away from the central portion.

The rate of movement within the margin is determined by a margin panning or scrolling algorithm. There are many variations of suitable margin panning or scrolling algorithms taking into account various factors such as the direction of panning or scrolling when the pointer (e.g., cursor, finger) enters the margin, the speed of panning at that moment, which margin the pointer entered, and the relative position of the pointer within the margin. At least one example margin panning or scrolling algorithm is described herein, which considers which margin the pointer entered and the relative position of the pointer within the margin relative to the central portion.

In the example margin panning or scrolling algorithm, the rate of movement (e.g. panning, scrolling) is directly proportional to a position of the pointer within the margin. At an inside edge, away from the perimeter of the displayable region, the rate of movement is some defined value, e.g., a minimum rate, such as zero pixels per second. At the perimeter edge, the rate of movement is some defined value, e.g., a maximum rate, such as 1000 pixels per second. At any point in between, the rate of movement is proportional to the position of that point relative to the two edges of the margin and the minimum and maximum rates.

In the exemplary margin panning or scrolling algorithm, the direction of movement may be dependent on which of two or more margins the pointer entered. For example, if the pointer enters at a top margin, then the object contents will appear to move relatively downward on the display.

The margin panning or scrolling algorithm can produce the effect of “accelerated panning” whereby the movement (e.g., panning, scrolling) accelerates as the pointer moves further into the margin relative to a central portion. When a dragging action starts in the central portion of the object representation, the object representation appears to move synchronously with the pointer. When pointer reaches an inside edge of a margin, panning continues at a minimum rate. If the pointer moves further into the margin, relatively away from the central region, the rate of movement (e.g., panning, scrolling) increases. The further the pointer moves in the margin, the higher the rate of movement, until the pointer reaches the extremity, boundary or outer perimeter of the object representation. At the perimeter, movement becomes fixed at the maximum rate. When the object is positioned as desired, the dragging action can be completed, for example by the user lifting their finger. Alternatively, the dragging action can continue, for example via movement of the finger, without letting up, to one of the other margins, to move (e.g., pan, scroll) in a different direction. Also alternatively, the dragging action can continue, for example via movement of the finger, without letting up, back to the central area, where in response synchronous movement (e.g., panning, scrolling) occurs, allowing a user to precisely position the object.

The accelerated panning or scanning can advantageously facilitate panning or scrolling through long lists or other object representations, for example by moving a pointer (e.g., finger, cursor) along one axis. In this case, “active” margins (i.e., margins in which placement of a pointer effects movement, e.g., panning, scrolling) may be located only at two ends of the object, the margins opposed to one another across a central portion along the desired axis.

This summary describes an exemplary algorithm, and the approaches described herein are not limited to the example. In general, the rate of movement (e.g., panning, scanning) is dependent on the location of the pointer (e.g., finger) in the margin, initial conditions of when the pointer enters the margin, and any algorithm or parameters used to determine and effectuate the movement based on these factors. As well, other input could be used to indicate the position of the pointer, such as pressure on the display, proximity sensor output, or output from other sensors.

The present invention is directed to a method executable on a mobile phone, tablet, or other touch enabled display that satisfies the need for a user to precisely pan an object representation in one operation. The invention also satisfies the need for a user to precisely select a desired value from a large sequential set of values in one operation.

In the following, we shall expect the display to contain a region to show the currently selected value and a “controller” region for selecting a desired value. In some embodiments, the controller will display the currently selected value and several values on either side of the selected value according to defined sequence. Further, we incorporate into the controller the “margin” areas we defined in the principal document. If the user drags his finger in the center area, the selected value changes linearly with the finger movement. If the user drags into the margin area, the selected value changes at a higher rate. The rate the selected value changes is determined by a margin algorithm, as previously discussed in the principal document.

Using the example margin algorithm in the principal document, the rate the selected value changes is directly proportional to the position of the finger within the margin. At the inside edge (away from the perimeter of the displayable region), the pan rate is some minimum ad hoc value, such as zero. At the perimeter edge, the pan rate is some ad hoc maximum value, such as 20 values per second. At any point in between, the rate is proportional to the position of that point relative to the two edges of the margin and the minimum and maximum values.

In our example algorithm, the direction of panning is dependent on which margin the finger entered. For example, if the finger enters the top margin, then the selected value will increase along the defined sequence. If the finger enters the bottom margin, then the selected value will decrease along the defined sequence.

By restricting panning along one axis we can easily use the accelerated panning method to scroll through a long sequence. In this case, only the margin areas at the two ends of the controller along the desired axis are employed.

While we have described a method to apply accelerated panning to a controller, we intend that the controller can also work in the traditional way: with multiple drag operations and fling actions.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a plan view of a portion of a display showing a user interface element including a list representation where accelerated scrolling is possible along its vertical axis.

FIG. 2 shows an image representation where accelerated scrolling is possible along its vertical and horizontal axes.

FIG. 3 shows an image representation in a circular form where accelerated scrolling is possible along any axis.

FIG. 4 shows two list representations side by side where horizontal accelerated panning moves from list to list and vertical accelerated panning scrolls a list's contents.

FIG. 5 shows a list representation and accelerated panning of the list during a drag and drop operation.

FIG. 6 shows a region to display a selected value and, below it, a controller showing a ribbed pattern for selecting a value from a sequence using accelerated panning.

FIG. 7 shows a time selector with a region to display a selected value and a controller. In this embodiment, the controller also shows values such that the selected value is highlighted in the controller.

FIG. 8 shows the same time selector as in FIG. 7. In this case we show that the user has selected a value considerably earlier in the sequence by using accelerated panning.

FIG. 9 shows a region to display a selected color and a controller with two axes. One axis is for selecting the color along the frequency spectrum. The other axis is for selecting the saturation from no color to full color.

FIG. 10 shows a pair of selected value and controller combinations, each combination similar to FIG. 7.

FIG. 11 is a block diagram of an example processor-based device used to implement one or more of the user interface approaches described herein, according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with processor-based devices and displays for processor-based devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Those of skill in the art will appreciate that in various implementations certain acts may be omitted and/or additional acts may be added. Those of skill in the art will also appreciate that the illustrated order of acts of a method, processor or algorithm are shown for exemplary purposes only, and may change in various implementations.

### Scrolling a Long List

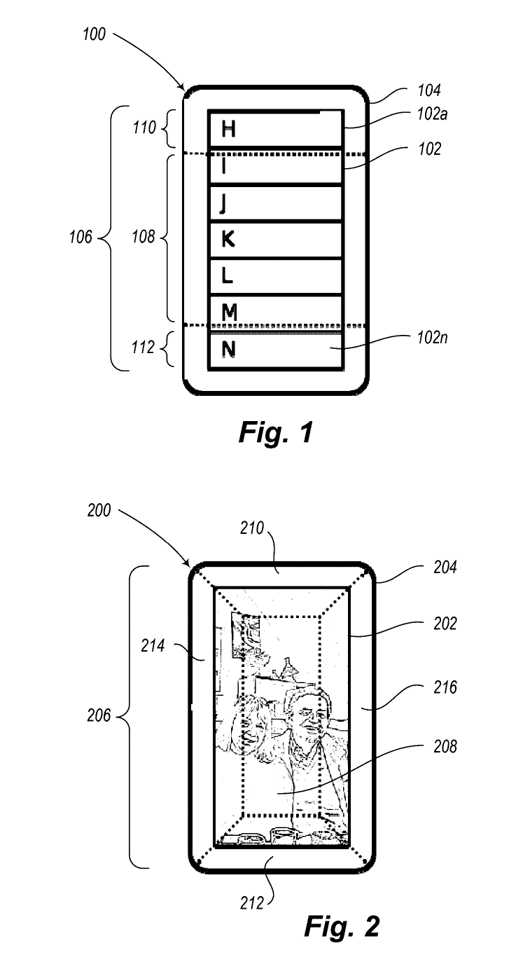

FIG. 1 shows a user interface element 100 that includes a scrollable list of selectable items representations or virtual elements 102 presented on a display, for example on a touch-enabled display 104, according to at least one illustrated embodiment. As illustrated, the user interface element 100 may occupy an entire area of a display or screen, or an entire area of a window presented via a display or screen, or may occupy only a portion of the display or screen.

The user interface element 100 includes a first region 106 having a central area or portion 108, a top margin 110, and a bottom margin 112. The bottom margin 112 is diametrically opposed across the central area or portion 108 from the top margin 110. The list is represented as a set or array of selectable item representations or virtual elements 102a-102n arranged vertically on the touch-enabled display 104. As illustrated, a topmost list item representation 102a of the list item representations or virtual elements 102 is the letter “H” and a bottommost list item representation 102n of the list item representations or virtual elements 102 is the letter “N”.

The contents of the scrollable list of selectable items representations or virtual elements 102 can be scrolled downward so that topmost selectable item representation or virtual element 102a “H” would appear further down on the display and other item representations or virtual elements (not visible in FIG. 1) would appear above it. The contents of the list of selectable items representations or virtual elements 102 can also be scrolled upward so that bottommost selectable item representation or virtual element 102n “N” would appear further up on the display and other item representations (not visible in FIG. 1) would appear below it.

In the implementation of FIG. 1, panning or scanning is available along only one axis, for example aligned vertically on the touch-enabled display 104. Thus, the user interface element has three distinct areas (i.e., central area or portion 108, top margin 110, and bottom margin 112) in which placement of a pointer (e.g., finger, stylus, cursor) will effect presentation of the scrollable list of selectable items or virtual elements 102.

Broken lines delineate these distinct areas in FIG. 1. The broken lines may represent a visual effect produced on the display screen (e.g., touch-enabled display 104). In general, it may not be necessary to graphically or visually show any delineation of these areas. Alternatively, if desired, delineation of these areas can be achieved via other visual effects, for example shading or graphics exterior to the list representation. While FIG. 1 shows the delineated areas extending to edges of the display screen or window; in general, could the delineated areas can be restricted to the perimeter of area of the list representation. These generalizations also apply to the other implementations discussed herein.

When the user performs a drag operation by making an initial selection of an object representation or virtual element in the central area or portion 108, the processor causes the list representation 102 to scroll synchronously with movement of the pointer (e.g., finger, stylus, cursor). If the user stops moving the pointer while the pointer is in the central area or portion 108, the processor stops the scrolling of the list representation 102. When the pointer is in the top margin 110, the processor causes the list contents 102 to scroll downward at a rate determined via a margin panning or scrolling algorithm. This rate may vary based on a relative position of the pointer in the top margin 110. For example, the higher the pointer is in the top margin 110, the higher the scroll rate. When the pointer is in the bottom margin 112, the processor causes the list contents to scroll upward at a rate determined via the margin panning or scrolling algorithm. This rate may vary based on a relative position of the pointer in the top margin 112. For example, lower the pointer is in the bottom margin 112, the higher the scroll rate. When the list representation 102 is fully scrolled to one end or the other of its contents, the processor causes the scrolling to halt.

It is not necessary for the list to have a vertical orientation. A list representation 102 can be oriented along any axis (e.g., vertical, horizontal, diagonal). Also, any desired margin panning or scrolling algorithm may be used, with any desired parameters (e.g., ratio of scroll rate to distance in margin from central region or portion 108). For example, the scroll rate can vary linearly with respect to distance in margin 110, 112 from central region or portion 108. Alternatively, the scroll rate can vary nonlinearly with respect to distance in margin 110, 112 from central region or portion 108.

This approach advantageously allows a user to precisely and rapidly pan or scroll to any point in the list representation 102 in one operation or one interaction via the user interface element 100.

### Accelerated Scrolling Along Two Axes

FIG. 2 shows a user interface element 200 that includes a pannable image representation or virtual element 202 presented on a display, for example on a touch-enabled display 204, according to at least one illustrated implementation. As illustrated, the user interface element 200 may occupy an entire area of a display or screen, or an entire area of a window presented via a display or screen, or may occupy only a portion of the display or screen.

The user interface element 200 includes a first region 206 having a central area or portion 208,:, a top margin 210, a bottom margin 212, a right margin 214, and a left margin 216). The bottom margin 212 is diametrically opposed across the central area or portion 208 from the top margin 210. The left margin 216 is diametrically opposed across the central area or portion 208 from the right margin 214. An axis between the top and bottom margins 210, 212 may extend vertically on the display (e.g., touch-enabled display 204). An axis between the right and left margins 214, 216 may extend horizontally on the display (e.g., touch-enabled display 204).

As described below, the image representation or virtual element 202 can be panned in any direction. Thus, the user interface element 200 has five distinct areas (i.e., central area or portion 208, top margin 210, bottom margin 212, right margin 214, and left margin 216) in which placement of a pointer will effect presentation of the pannable image representation or virtual element 202. Broken lines delineate these distinct areas in FIG. 2. The broken lines may represent a visual effect produced on the display screen (e.g., touch-enabled display 204). In general, it may not be necessary to graphically or visually show any delineation of these areas. Alternatively, if desired, delineation of these areas can be achieved via other visual effects, for example shading or graphics exterior to the list representation.

When the user performs a drag operation by making an initial selection of an object representation or virtual element 202 in the central area or portion 208, the processor causes the image representation or virtual element 202 to pan synchronously with movement of the pointer (e.g. finger, stylus, cursor). If the user stops moving the pointer while the pointer is in the central area or portion 208, the processor stops the panning of the image representation or virtual element 202. When the pointer is in the top margin 210, the processor causes the image representation or virtual element 202 to pan or scroll downward at a rate determined via a margin panning or scrolling algorithm. The higher the pointer is in the top margin 210, the higher the scroll rate. When the pointer is in the bottom margin 212, the processor causes the image representation or virtual element 202 to pan or scroll upward at a rate determined via the margin panning or scrolling algorithm. The lower the pointer is in the bottom margin 212, the higher the scroll rate. When the pointer is in the left margin 214, the processor causes the image representation or virtual element 202 to pan or scroll rightward at a rate determined via the margin panning or scrolling algorithm. The further left the pointer is in the left margin 214, the higher the scroll rate. When the pointer is in the right margin 216, the processor causes the image representation or virtual element 202 to pan or scroll leftward at a rate determined via the margin panning or scrolling algorithm. The further right the pointer is in the right margin 216, the higher the scroll rate. When the image representation or virtual element 202 is fully scrolled to the extremity of its contents, the processor causes the panning or scrolling to halt. Any desired margin panning or scrolling algorithm may be used, with any desired parameters (e.g., ratio of scroll rate to distance in margin from central region or portion). For example, the scroll rate can vary linearly with respect to distance in margin 210, 212, 214, 216 from the central region or portion 208. Alternatively, the scroll rate can vary nonlinearly with respect to distance in margin 210, 212, 214, 216 from the central region or portion 208. This approach advantageously allows a user to precisely and rapidly pan or scroll to any point in the image representation or virtual element 202 in one operation or one interaction via the user interface element 200.

### Accelerated Scrolling in Any Direction

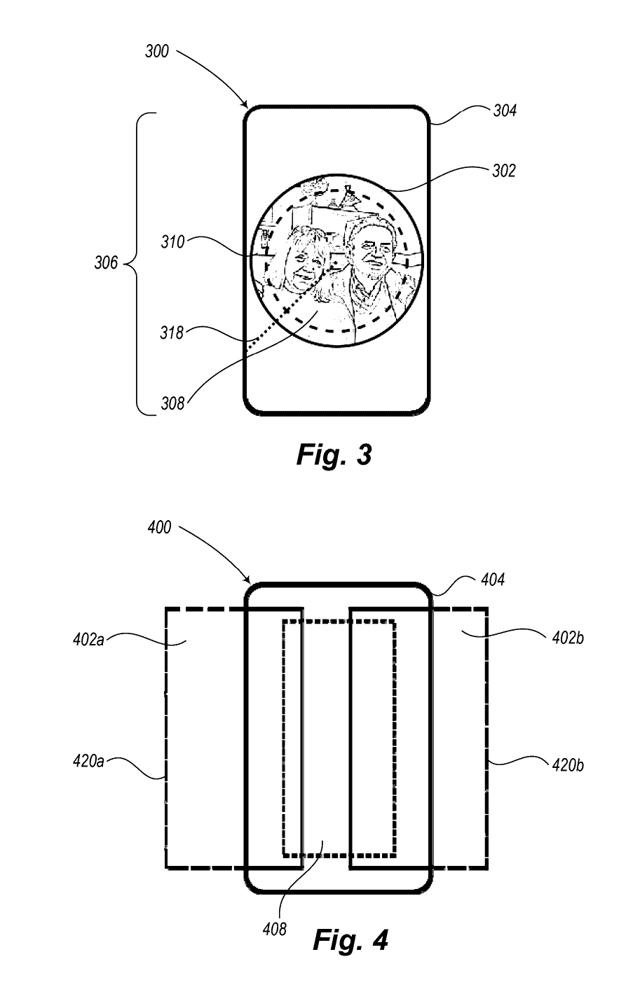

FIG. 3 shows a user interface element 300 that includes a pannable image representation or virtual element 302 presented on a display, for example a touch-enabled display 304, according to at least one illustrated implementation. As illustrated, the user interface element 300 may occupy an entire area of a display or screen, or an entire area of a window presented via a display or screen, or may occupy only a portion of the display or screen.

The user interface element 300 includes a first region 306 having a central area or portion 308 encompassed by a margin 310. The first region 306 and the central area or portion 308 can both be circular or elliptical, while the margin 310 may be annular or an annulus.

As described below, the pannable image representation or virtual element 302 can be panned in any direction. Thus, the user interface element 300 has two distinct areas (i.e., central area or portion 308, margin 310) in which placement of a pointer will effect presentation of the pannable image representation or virtual element 302. A broken line delineate these distinct areas in FIG. 3. The broken line may represent a visual effect produced on the display screen (e.g., touch-enabled display 304). In general, it may not be necessary to graphically or visually show any delineation of these areas. Alternatively, if desired, delineation of these areas can be achieved via other visual effects, for example shading or graphics exterior to the list representation.

When the user performs a drag operation by making an initial selection of an object representation or virtual element 302 in the central area or portion 308, processor causes the image representation or virtual element 302 to pan pointer (e.g. synchronously with the finger, stylus, cursor). If the user stops moving the pointer while the pointer is in the central area or portion 308, the processor stops the panning of the image representation or virtual element 302. When the pointer is in the margin area 310, the processor causes the image representation or virtual element 302 to pan or scroll along an axis aligned with a radial from a center of the viewable area (not necessarily a center of the image representation or virtual element 302) to the point where the pointer is at in the margin. A sample radial is shown in FIG. 3 by a heavy broken line 318. The further the pointer is in the margin 310, the faster the rate of panning or scrolling. The rate of panning or scrolling is determined via a margin panning or scrolling algorithm. When the image representation 302 is fully panned, the processor halts the panning or scrolling at least until the pointer moves in a different direction. Any desired margin panning or scrolling algorithm may be used, with any desired parameters (e.g., ratio of scroll rate to distance in margin 310 from central region or portion 308). For example, the scroll rate can vary linearly with respect to distance in margin 310 from central region or portion 308. Alternatively, the scroll rate can vary nonlinearly with respect to distance in margin 310 from central region or portion 308. This approach advantageously allows a user to precisely and rapidly pan or scroll to any point in the image representation or virtual element 302 in one operation or one interaction via the user interface element 300.

It is not necessary for the image representation or its viewable area to have the form of a circle or ellipse. It could have the form of a rectangle or any other shape. The same radial approach of determining the panning axis could still be applied or variations of that approach, such as a combination of the radial approach and the fixed axis approach.

### Nesting Scrollable Objects Inside Another Scrollable Object

FIG. 4 shows a user interface element 400 in the form of a page viewer, according to at least one illustrated implementation. As illustrated, the page viewer may occupy an entire area of a display or screen, or an entire area of a window presented via a display or screen. As illustrated, the page viewer presents two object representations or virtual objects, in the form of first and second page representations 402a, 402b, respectively. The page representations 402a, 402b can, for example, be presented in a side by side arrangement on a display screen, for example a touch-enabled display 404. The page representations 402a, 402b can, for example, represent two or more Internet browser pages, graphically arranged side by side. Part of each page representation 402a, 402b is not visible because the part is outside the display area. (Applicant notes that such can, for example represent image information that defines the page, but which may not be rendered to the display, or may not be yet loaded to an image buffer.) The perimeter of these parts are represented with broken lines 420a, 420b. The horizontal accelerated panning or scanning approached described herein allows the user to pan or scroll left or right to view either page representation 402a, 402b in full. The vertical accelerated panning or scanning approached described herein allows the user to pan or scroll a selected page representation 402a, 402b along its vertical axis in either direction. The selected page representation 402a, 402b is the first page representation 402a, 402b selected (e.g., touched with finger or stylus, or indicated with cursor) in a drag operation. While FIG. 4 shows two page representations 402a, 402b, any number of page representations can be presented. Further, while FIG. 4 shows two page representations 402, 402b oriented or arranged horizontally across a display, page representations 402a, 402b can alternatively or additionally be arranged in other directions, for example vertically across the display.

The page viewer user interface element 400 includes a first region having a central area 408 and a margin 4410.

A user can scroll horizontally among pages in the same or similar manner as described with respect to FIG. 1, except that the scrolling axis is horizontal instead of vertical.

When the user performs a drag operation by making an initial selection of an object representation or virtual element 402a, 402b in the central area or portion 408 to the left or to the right of a vertical centerline (not illustrated), the processor causes the page viewer contents (e.g. sequence of page representations 402a, 402b) to scroll or pan left or right, respectively, synchronously with movement of the pointer. If the pointer enters the left area of the margin 410, the page viewer contents scrolls right at a rate determined via a margin panning or scrolling algorithm. The further left the pointer is in the left area of the margin 410, the higher the scroll or pan rate. If the pointer enters the right area of the margin 410, the processor causes the page viewer contents to scroll or pan left at a rate determined via the margin panning or scrolling algorithm. The further right the pointer is in the right area of the margin 410, the higher the scroll or pan rate. When the page viewer representation is fully scrolled to the extremity of its contents, the processor causes the scrolling to halt.

Any desired margin panning or scrolling algorithm may be used, with any desired parameters (e.g., ratio of scroll rate to distance in margin 410 from central region or portion 408). For example, the scroll rate can vary linearly with respect to distance in margin 410 from the central region or portion 408. Alternatively, the scroll rate can vary nonlinearly with respect to distance in margin 410 from the central region or portion 408.

The user can scroll vertically within a specific page in the same or similar manner as described with respect to FIG. 1.

When a user performs a drag operation by making an initial selection of an object representation or virtual element 402a, 402b in the central area or portion 408 above (e.g., upward) or below (e.g., downward) with respect to a horizontal centerline (not illustrated), the processor causes the selected page contents 402a, 402b to scroll or pan up or down, respectively, synchronously with the movement of the pointer. If pointer enters a top area of the margin 410, the processor causes the selected page contents to scroll or pan down at a rate determined via panning or scrolling the margin algorithm. The further up the pointer is in top area of the margin 410, the higher the scroll rate. If the pointer enters a bottom area of the margin 410, the processor causes the selected page contents to scroll or pan up at a rate determined via the margin panning or scrolling algorithm. The further down the pointer is in the bottom area of the margin 410, the higher the scroll rate. When the page representation is fully scrolled to the extremity of its contents, the processor causes halts the scrolling or panning.

Any desired margin panning or scrolling algorithm may be used, with any desired parameters (e.g., ratio of scroll rate to distance in margin from central region or portion). For example, the scroll rate can vary linearly with respect to distance in margin 410 from the central region or portion 408. Alternatively, the scroll rate can vary nonlinearly with respect to distance in margin 410 from the central region or portion 408.

As described above, the page representation 402a, 402b is vertically scrollable. In another implementation, the page representation 402a, 402b could be fixed (i.e., not scrollable) but virtual objects or virtual elements within a page could have scrollable or pan-able representations. For example, a page representation 402a, 402b might contain two scrollable lists. To scroll a list, the user begins a drag operation in the virtual representation the desired list. The approach can be applied as long as the page viewer representation scrolls along a different axis than the scrollable list representations 402a, 402b. Various implementations can use any pair of axes orientations, not just horizontal and vertical axes.

In at least one implementation, scrolling or panning may be limited to along one axis or the other, the axis dependent on the initial direction of movement of the pointer (e.g., finger). For example, if a user begins a drag operation by moving more in the vertical direction than horizontal, the processor causes scrolling or panning only along the vertical axis for the duration of the operation or user interaction. Also for example, if a user begins a drag operation by moving more in the horizontal direction than vertical, the processor causes scrolling or panning only along the horizontal axis for the duration of the operation or user interaction.

This approach advantageously allows a user to precisely and rapidly pan or scroll to any point in the list representation in one operation or one interaction via the user interface element 400.

### Accelerated Scrolling During Drag and Drop Operations

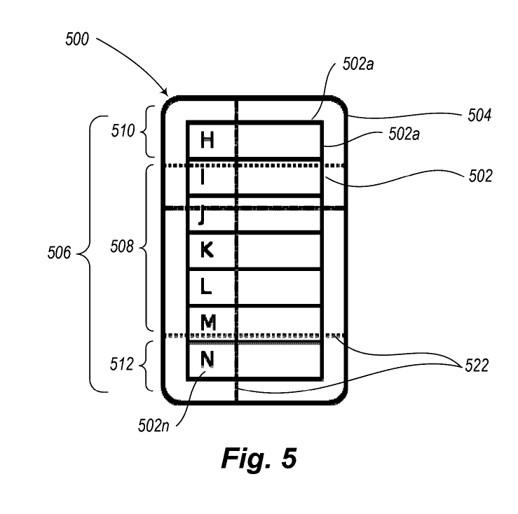

FIG. 5 shows a user interface element 500 that includes a scrollable list of selectable item representations or virtual elements 502 presented on a display, for example on a touch-enabled display 504, according to at least one illustrated embodiment. As illustrated, the user interface element 500 may occupy an entire area of a display or screen, or an entire area of a window presented via a display or screen, or may occupy only a portion of the display or screen.

The user interface element 500 includes a first region 506 having a central area or portion 508, a top margin 510, and a bottom margin 512. The bottom margin 512 is diametrically opposed across the central area or portion 508 from the top margin 510. The list is represented as a set or array of selectable item representations or virtual elements 502a-502n (two called out in FIG. 5) arranged vertically on the display, e.g., touch-enabled display 504.

The contents of the list representation 502 can be scrolled up or down to show other selectable item representations or virtual elements not otherwise visible due to the limited viewable area of the user interface element. (Applicant notes that such can, for example represent image information that defines the page, but which may not be rendered to the display, or may not be yet loaded to an image buffer.) In particular, the user can perform a drag and drop operation with a source object (not indicated) and a pointer (e.g., finger), the position of the pointer is shown by crosshairs 522 located in the area of list representation 502.

The user interface element 500 has three distinct areas (i.e., central area or portion 508, top margin 510, and bottom margin 512 in which placement of a pointer will effect presentation of the pannable image representation or virtual element 502. Broken lines delineate these distinct areas in FIG. 5. The broken lines may represent a visual effect produced on the display screen (e.g., touch-enabled display 504). In general, it may not be necessary to graphically or visually show any delineation of these areas. Alternatively, if desired, delineation of these areas can be achieved via other visual effects, for example shading or graphics exterior to the list representation.

This implementation advantageously allows a user to scroll a list representation 502 without interrupting a drag and drop operation, such that a desired position to complete the drag and drop operation is brought into view.

While performing the drag and drop operation, if the pointer (e.g., finger, stylus, cursor) is in the central area or portion 508, the processor causes the list to not scroll or pan, and the location of the pointer indicates the position at which the drag and drop operation will be completed (e.g., object representation or virtual element will be positioned) if the user then lifts the finger or stylus up or releases the button on a computer mouse or trackball. If, while performing the drag and drop operation, the pointer moves into the top margin 510, the processor causes the list contents to scroll or pan down at a rate determined via a margin panning and scrolling algorithm. The higher the pointer is in the top margin 510, the higher the scroll rate. If, while performing the drag and drop operation, the pointer moves into the bottom margin 512, the processor causes the list contents to scroll or pan up at a rate determined by the margin panning and scrolling algorithm. The lower the pointer is in the bottom margin 512, the higher the scroll rate. When the list representation 502 is fully scrolled to one end or the other of its contents, the processor causes the scrolling to halt. It is not necessary for the list representation 502 to have a vertical orientation. A list representation 502 can be oriented along any axis (e.g., horizontal axis, diagonal axis).

Any desired margin panning or scrolling algorithm may be used, with any desired parameters (e.g., ratio of scroll rate to distance in margin from central region or portion). For example, the scroll rate can vary linearly with respect to distance in margin 510, 512 from the central region or portion 508. Alternatively, the scroll rate can vary nonlinearly with respect to distance in margin 510,512 from the central region or portion 508. This approach advantageously allows a user to precisely and rapidly pan or scroll to any point in the list representation or virtual element 502 in one operation or one interaction via the user interface element 500.

This approach advantageously allows a user to precisely and rapidly perform a drag and drop operation, without interruption, on a long list, completing the drag and drop operation at the desired position anywhere in the list in one operation or one interaction via the user interface element.

### Incremental Spinner

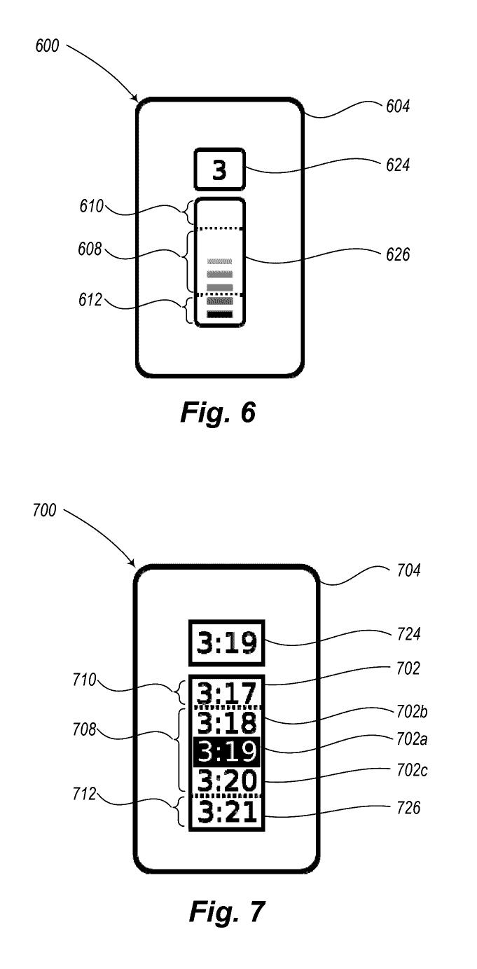

FIG. 6 shows a user interface element 600 that includes a first region 606 with a currently identified value portion 624 and a controller 626 presented on a display, for example on a touch-enabled display 604, according to at least one illustrated embodiment. As illustrated, the user interface element 600 may occupy an entire area of a display or screen, or an entire area of a window presented via a display or screen, or may occupy only a portion of the display or screen.

The currently identified value portion 624 displays a currently identified value from a set of values. The controller 626 includes a central area or portion 608, a top margin 610, and a bottom margin 612. The bottom margin 612 is diametrically opposed across the central area or portion 608 from the top margin 610. A visual appearance of the controller 626 may mimic an edge of a spinning wheel or reel, for instance similar to a reel of a slot machine.

FIG. 6 shows a currently identified value as “3” which represents a possible selection from a set that comprises a long contiguous sequence of integers. The illustrated controller 626 only reacts to motion of a pointer (e.g., finger, stylus, cursor) along one axis, for example a vertical axis.

The controller 626 has three distinct areas (i.e., central area or portion 608, top margin 610, and bottom margin 612) in which placement of a pointer will effect presentation of the identified value in the currently identified value region 624. Broken lines delineate these distinct areas of the controller in FIG. 6. The broken lines may represent a visual effect produced on the display screen (e.g., touch-enabled display 604). In general, it may not be necessary to graphically or visually show any delineation of these areas. Alternatively, if desired, delineation of these areas can be achieved via other visual effects, for example shading or graphics exterior to the list representation.

When a user performs a drag operation in the central area or portion 608 of the controller 626, a processor causes the currently identified value presented in the currently identified value portion 624 to change linearly with a vertical movement of a pointer (e.g., finger, stylus, cursor). For example, if the user drags upward in the central area or portion 608, the processor causes the value being presented in the currently identified value portion 624 to sequentially get smaller (i.e., decrement) at a first rate. Also for example, if the user drags downward in the central area or portion 608, the processor causes the value being presented in the currently identified value portion 624 to sequentially get larger (i.e., increment). If the user stops moving the pointer, the processor causes the value being presented in the currently identified value portion 624 to stop changing. When the pointer is in the top margin 610, processor causes the value being presented in the currently identified value portion 624 to increase at a rate determined via a margin panning or scanning algorithm. The higher the pointer is in the top margin 610, the faster the value being presented in the currently identified value portion 624 increases. When the pointer is in the bottom margin 612, processor causes the value being presented in the currently identified value portion 624 to decrease at a rate determined via the margin panning or scanning algorithm. The lower the pointer is in the bottom margin 612, the faster the value being presented in the currently identified value portion 624 decreases.

When the value being presented in the currently identified value portion 624 has reached an upper limit for a defined sequence, the processor causes the incrementing of the value being presented in the currently identified value portion 624 to halt, even if the pointer continues to linger in the top margin 210. When the value being presented has reached a lower limit for a defined sequence, the processor causes the decrementing of the value being presented in the currently identified value portion 624 to halt, even if the pointer continues to linger in the bottom margin 612. When the user lets up, releases or otherwise deactivates the pointer, the processor causes the incrementing and/or decrementing of the value being presented in the currently identified value portion 624 to halt.

This approach advantageously allows a user to precisely and rapidly select a value from a very long sequence of values in one operation or user interaction (e.g., a single drag interaction).

### Incremental Spinner With Selectable Values

FIG. 7 shows a user interface element 700 that includes a currently identified value portion 724 and a controller 726 presented on a display, for example on a touch-enabled display 704, according to at least one illustrated embodiment. As illustrated, the user interface element 700 may occupy an entire area of a display or screen, or an entire area of a window presented via a display or screen, or may occupy only a portion of the display or screen.

The currently identified value portion 724 displays a currently identified value from a set of values. The controller 726 includes a central area or portion 708, a top margin 710, and a bottom margin 712. The bottom margin 712 is diametrically opposed across the central area or portion 708 from the top margin 710. A visual appearance of the controller 726 may mimic an edge of a spinning wheel or reel, for instance similar to a reel of a slot machine.

FIG. 7 shows a currently presented identified value as the representation “3:19” 702a which represents a possible selection from a sequence of the hours and minutes in a day. The controller 726 also shows a contiguous subset of immediately proximate values from the sequence, ranging for example from “3:17 to “3:21” 702b, 702c (only two called out in FIG. 7) along the edge of the “reel” above and below the currently presented identified value 702a. A currently presented selected value 702a that would be selected by completing the user interaction is indicated by a visual effect in the controller 706, for example by shading. In general, a different visual effect may be employed to represent the currently presented identified value 702a that would be selected by completion of the user interaction. Alternatively, no visual effect may be employed. The illustrated controller 726 only reacts to motion of a pointer (e.g., finger, stylus, cursor) along one axis, for example a vertical axis.

The controller 726 has three distinct areas (i.e., central area or portion 708, top margin 710, and bottom margin 712) in which placement of a pointer will effect presentation of the scrollable list of value representations or virtual elements 702 as well as the presentation of the currently identified value in the currently identified value portion 724. Broken lines delineate these distinct areas in FIG. 7. The broken lines may represent a visual effect produced on the display screen (e.g., touch-enabled display 7.04). In general, it may not be necessary to graphically or visually show any delineation of these areas. Alternatively, if desired, delineation of these areas can be achieved via other visual effects, for example shading or graphics exterior to the list representation.

When a user performs a drag operation in the central area or portion 708, a processor causes the identified value presented in the currently identified value portion 724 to change to a value presented in an area in which the pointer (e.g., finger, stylus, cursor) is located. The processor also causes the values presented in the controller 726 to update. For example, if the pointer is located at the position where the representation of “3.18” is displayed, “3.18” will become the identified value presented in the currently identified value portion 724 and in the central position in the controller 726. If the user drags the pointer to another part of the central area or portion 708, the processor will change the presented identified value to the value shown in the area to which the pointer has moved. For example, if a user begins a drag operation or interaction by moving a pointer to indicate the representation “3.18” and then the drags the pointer downward, when the pointer points to the representation of “3.19”, the processor updates the identified value presented in the currently identified value portion 624 to be the representation of “3.19”.

When the pointer is in the top margin 710, the processor causes the identified value presented in the currently identified value portion 724 to increase at a rate determined via a margin pan or scrolling algorithm. The higher the pointer is in the top margin 724, the faster the identified value increases. When the pointer is in the bottom margin 712, the processor causes the identified value presented in the currently identified value portion 724 to decrease at a rate determined via the margin panning or scrolling algorithm. The lower the pointer is in the bottom margin 712, the faster the value presented in the currently identified value portion 724 decreases. When the identified value reaches an upper limit of a defined sequence, the processor causes the incrementing to halt, even if the pointer lingers in the top margin 710. When the identified value reaches a lower limit of the defined sequence, the processor causes the decrementing to halt, even if the pointer lingers in the bottom margin 712. When the user lets up, releases or otherwise deactivates the pointer, the processor causes the incrementing and/or decrementing of the identified value being presented to halt.

Synchronously with the changing of the identified value, described above, the other value representations displayed in the controller 726 are updated (e.g., scrolled) such that the presented identified value is always displayed in the controller 726 along with contiguous subset of immediately proximate values.

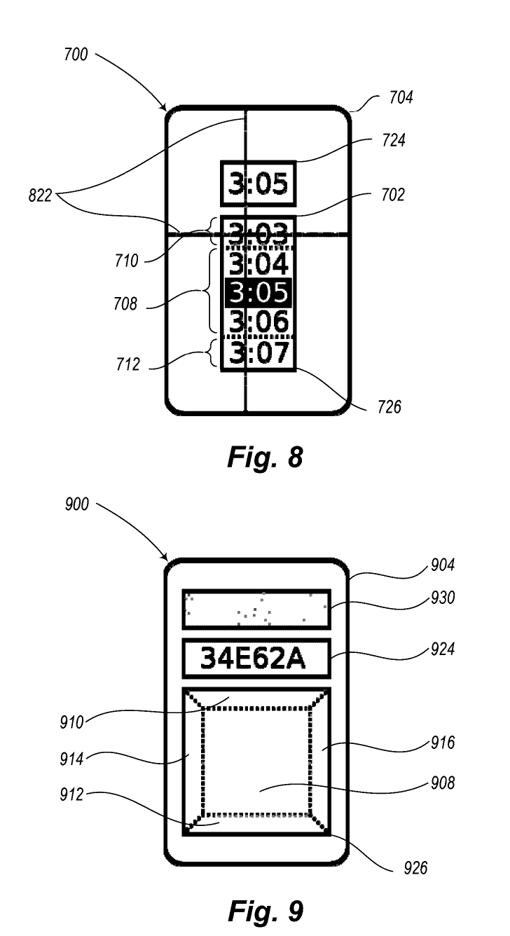

FIG. 8 shows the user interface element 700 of FIG. 8, except that pointer, shown by crosshairs 822, is located in the top margin 710, and the processor caused a presentation of the identified value to be updated to the representation “3:05”.

If the user drags the pointer from a margin area 710, 712 into the central area or portion 708, the processor causes the value representations being presented in the controller 726 to stop scrolling, allowing the user to select one of the value representations presented in the central area or portion by a selection action (e.g., touching the corresponding area of the display with a finger or stylus, clicking a button on a computer mouse or trackball while a cursor is positioned in the corresponding area of the display.

This approach advantageously allows a user to precisely and rapidly select a value from a very long sequence and allows for correction of overshooting by moving the pointer into the central area or portion and selecting a specific one of the presented value representations.

### Incremental Spinner Along Two Axes

FIG. 9 shows a user interface element 900 that includes a currently identified value field or portion 924, a controller 926, and an input field 930 presented on a display, for example on a touch-enabled display 904, according to at least one illustrated embodiment. As illustrated, the user interface element 900 may occupy an entire area of a display or screen, or an entire area of a window presented via a display or screen, or may occupy only a portion of the display or screen.

The currently identified value portion 924 displays a currently identified value from a set of values. The controller 926 includes a central area or portion 908, a top margin 910, a bottom margin 912, a left margin 914 and a right margin 916. The bottom margin 612 is diametrically opposed across the central area or portion 908 from the top margin 910. The right margin 916 is diametrically opposed across the central area or portion 908 from the left margin 914. A visual appearance of the controller 720 may, for example, mimic or resemble a rocker switch.

FIG. 9 shows a currently identified value presented in the currently identified value portion 924 as the representation “34E62A” which represents a selection from two sequences of values, along two different axes, e.g., vertical axis and horizontal axis. For example, the horizontal axis represents increments along a color spectrum from near-ultraviolet to near-infrared. For example, the vertical axis represents increments from zero color saturation (i.e., grey) to full color saturation.

The controller 926 has five distinct areas (i.e., central area or portion 908, top margin 910, bottom margin 912, left margin 914, right margin 916) in which placement of a pointer will effect presentation of the scrollable list of value representations or virtual elements as well as the presentation of the currently identified value in the currently identified value portion 924. Broken lines delineate these distinct areas in FIG. 9. The broken lines may represent a visual effect produced on the display screen (e.g., touch-enabled display 904). In general, it may not be necessary to graphically or visually show any delineation of these areas. Alternatively, if desired, delineation of these areas can be achieved via other visual effects, for example shading or graphics exterior to the list representation.

When a user types or otherwise enters values into the input field 930, the entered values becomes the identified value(s), and the processor causes the entered identified values to be presented in the currently identified value field or portion 924. Incrementing and/or decrementing start from the most current identified value(s).

When a user performs a drag operation in the central area or portion 908 a processor causes the identified value presented in the currently identified value portion 724 to change linearly with vertical and horizontal movements of a pointer (e.g., finger, stylus, cursor). If the user drags upward while in the central area or portion 908, the processor will decrement (i.e., sequentially get smaller) a first value (e.g., saturation component). If the user drags downward while in the central area or portion 908, the processor will increment (i.e., sequentially get larger) the first value (e.g., saturation component). If the user drags leftward while in the central area or portion 908, the processor will decrement (i.e., sequentially get smaller) a second value (e.g., color component). If the user drags rightward while in the central area or portion 908, the processor will increment (i.e., sequentially get larger) the second value (e.g., color component). If the user drags diagonally while in the central area or portion 908, the processor will concurrently change both the first value (e.g., saturation component) and the second value (e.g., color component) per a degree of movement along the respective axes. For example, if the user moves the pointer diagonally from left to right and from top to bottom while in the central area or portion 908, the processor increments the first value and concurrently decrements the second value, synchronously with movement of the pointer. If the user stops moving the pointer, the processor halts the decrementing and incrementing of the first and second values.

When the pointer is in the top margin 910, the processor increments the first value (e.g., saturation component) at a rate determined by a margin panning or scrolling algorithm. The higher the pointer is in the top margin 910, the faster the identified value increases. When the pointer is in the bottom margin 912, the processor decrements the first value (e.g., saturation component) at a rate determined via the margin panning and scrolling algorithm. The lower the pointer is in the bottom margin 912, the faster the identified value decreases. When the pointer is in the left margin 914, the processor decrements the second value (e.g., color component) at a rate determined via the margin panning and scrolling algorithm. The further left the pointer is in the left margin 914, the faster the identified value decreases. When the pointer is in the right margin 916, the processor increments the second value (e.g., color component) at a rate determined by the margin panning a scrolling algorithm. The further right the pointer is in the right margin 916, the faster the identified value increases. When the identified value reaches an upper limit of the defined respective sequence of values, the processor halts the incrementing, even if the pointer lingers in the top margin 910 or right margin 916. When the identified value reaches a lower limit of the defined respective sequence, the processor halts the decrementing, even if the pointer lingers in the bottom margin 912 or left margin 914. When the user lets up, releases or otherwise deactivates the pointer, the processor causes the incrementing and/or decrementing of the identified values being presented to halt.

The structures and aspects of the other described implementations can be applied to the implementation of FIG. 9 and vice versa. For example, the controller of FIG. 7 presents the current identified value as well as several adjacent values from a sequence. In the implementation of FIG. 9, the controller could present a grid of cells, one of which contains the presently identified value(s) (e.g., presented as a color or a numeric value or both) and the other cells of the grid populated with values adjacent the presently identified value(s) in the respective sequences (e.g., sequence of color component, sequence of saturation values).

The approach advantageously allows a user to precisely and rapidly select a value from a two dimensional combination of two long sequences in one operation or one user interaction (e.g., drag interaction).

### Pair of Incremental Spinners With Selectable Values

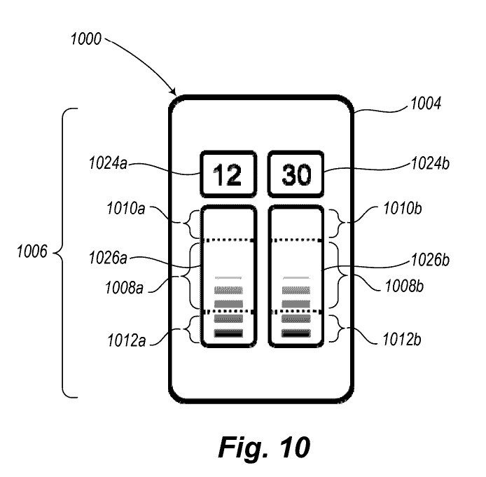

FIG. 10 shows a user interface element 1000 that includes a first region 1006 with a two currently identified value fields or portions 1024a, 1024b and two controllers 1024a, 1024b presented on a display, for example on a touch-enabled display 1004, according to at least one illustrated embodiment. As illustrated, the user interface element 1000 may occupy an entire area of a display or screen, or an entire area of a window presented via a display or screen, or may occupy only a portion of the display or screen.

The first currently identified value portion 1024a displays a currently identified value from a first set of values. The second currently identified value portion 1024b displays a currently identified value from a second set of values. The first controller 1026a includes a central area or portion 1008a, a top margin 1010b, and a bottom margin 1012c. The bottom margin 1012c is diametrically opposed across the central area or portion 1008a from the top margin 1010b. A visual appearance of the first controller 1026a may mimic an edge of a spinning wheel or reel, for instance similar to a reel of a slot machine. The second controller 1026b includes a central area or portion 1008b, a top margin 1010b, and a bottom margin 1012b. The bottom margin 1012b is diametrically opposed across the central area or portion 1008b from the top margin 1010b. A visual appearance of the second controller 1016b may mimic an edge of a spinning wheel or reel, for instance similar to a reel of a slot machine.

FIG. 10 shows a first currently identified value presented in the first currently identified value portion 1024a as the representation “12”, for example representing an hour of a day. FIG. 10 shows a second currently identified value presented in the second currently identified value portion 1024b as the representation “30”, for example representing a number of minutes in the currently identified hour of the day.

If the user performs a drag operation using the first controller (e.g., left spinner) 1026a, the processor increments or decrements the value of the currently identified value presented in the first currently identified value field or portion 1024a in the same manner as described with reference to the implementation of FIG. 6. If the user performs a drag operation using the second controller (e.g., left spinner) 1026b, the processor increments or decrements the value of the currently identified value presented in the second currently identified value field or portion 1024b in the same manner as described with reference to the implementation of FIG. 6.

In contrast to the implementation of FIG. 6 in which incrementing and decrementing are halted when upper and lower limits or boundaries of a sequence are reached, optionally, when the value being presented in the second currently identified value portion 1024b reaches an upper limit for a defined sequence, the processor causes the value presented in the first currently identified value portion 1024a to increment and causes the value being presented in the second currently identified value portion 1024b to be equal to a lower limit for the defined sequence. Also optionally, when the value being presented in the second currently identified value portion 1024b reaches a lower limit for a defined sequence, the processor causes the value presented in the first currently identified value portion 1024a to decrement and causes the value being presented in the second currently identified value portion 1024b to be equal to the upper limit for the defined sequence. Thus, when presenting hours and minutes, as the minutes are incremented and reach 59 minutes, the next incremental increase in minutes causes the presented hour value to increase by one and returns the minutes value to 0. Conversely, when presenting hours and minutes, as the minutes are decremented and reach 00 minutes, the next incremental decrease in minutes causes the presented hour value to decrease by one, and returns the minutes value to 59.

This approach can advantageously allow a user to easily select two related values, for example hours and minutes. This implementation can be applied to the other implementations we described herein. This implementation can also be applied to other implementations of drag and drop operations, such as the use of drop sockets.

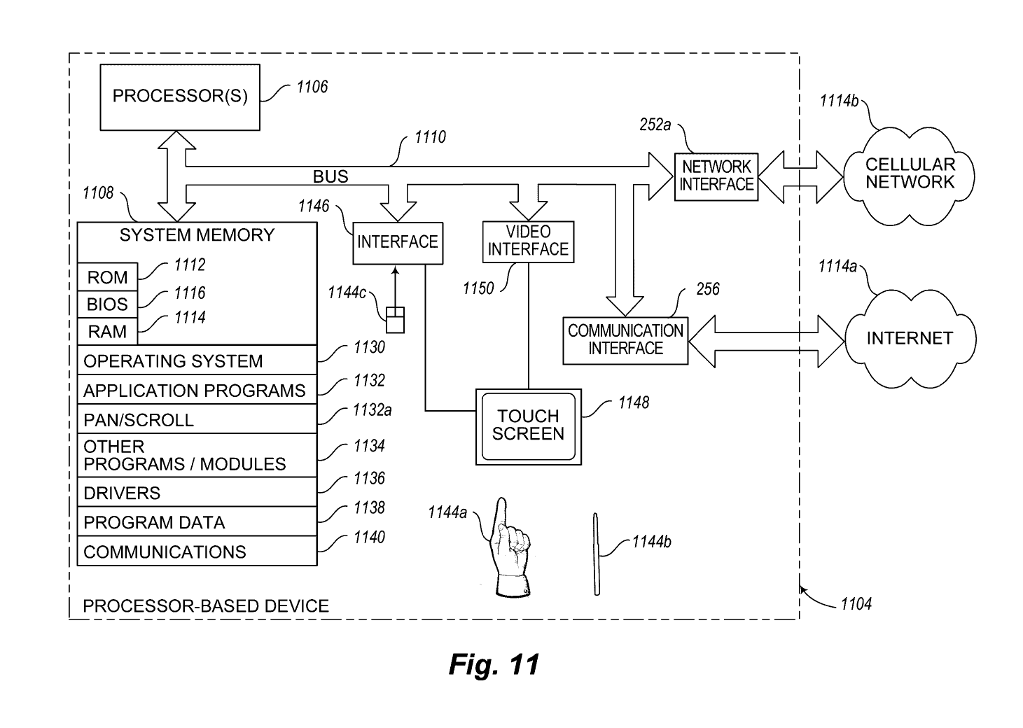

FIG. 11 shows a processor-based device 1104 suitable for implementing various embodiments described herein. Although not required, some portion of the embodiments will be described in the general context of processor-executable instructions or logic, such as program application modules, objects, or macros being executed by one or more processors. Those skilled in the relevant art will appreciate that the described embodiments, as well as other embodiments, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1104 may, for example, take the form of a smartphone or tablet computer, which includes one or more processors 1106, a system memory 1108 and a system bus 1110 that couples various system components including the system memory 1108 to the processor(s) 1106. The processor-based device 1104 will at times be referred to in the singular herein, but this is not intended to limit the embodiments to a single system, since in certain embodiments, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1106 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 11 are of conventional design. As a result, such blocks need not be described in further detail herein, as they will be understood by those skilled in the relevant art.

The system bus 1110 can employ any known bus structures or architectures, including a memory bus with memory controller, a peripheral bus, and a local bus. The system memory 1108 includes read-only memory (“ROM”) 1012 and random access memory (“RAM”) 1114. A basic input/output system (“BIOS”) 1116, which can form part of the ROM 1112, contains basic routines that help transfer information between elements within processor-based device 1104, such as during start-up. Some embodiments may employ separate buses for data, instructions and power.

The processor-based device 1104 may also include one or more solid state memories, for instance Flash memory or solid state drive (SSD) 1118, which provides nonvolatile storage of computer-readable instructions, data structures, program modules and other data for the processor-based device 1104. Although not depicted, the processor-based device 1104 can employ other nontransitory computer- or processor-readable media, for example a hard disk drive, an optical disk drive, or memory card media drive.

Program modules can be stored in the system memory 1108, such as an operating system 1130, one or more application programs 1132, other programs or modules 1134, drivers 1136 and program data 1138.

The application programs 1132 may, for example, include panning/scrolling 1132a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1132a may, for example, be stored as one or more executable instructions. The panning/scrolling logic 1132a may include processor and/or machine executable logic or instructions to generate user interface objects using data that characterizes movement of a pointer, for example data from a touch-sensitive display or from a computer mouse or trackball, or other user interface device.

The system memory 1108 may also include communications programs 1140, for example a server and/or a Web client or browser for permitting the processor-based device 1104 to access and exchange data with other systems such as user computing systems, Web sites on the Internet, corporate intranets, or other networks as described below. The communications programs 1140 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 11 as being stored in the system memory 1108, the operating system 1130, application programs 1132, other programs/modules 1134, drivers 1136, program data 1138 and server and/or browser 1140 can be stored on any other of a large variety of nontransitory processor-readable media (e.g., hard disk drive, optical disk drive, SSD and/or flash memory.

A user can enter commands and information via a pointer, for example through input devices such as a touch screen 1148 via a finger 1144a, stylus 1144b, or via a computer mouse or trackball 1144c which controls a cursor. Other input devices can include a microphone, joystick, game pad, tablet, scanner, biometric scanning device, etc. These and other input devices (i.e.,“I/O devices”) are connected to the processor(s) 1106 through an interface 1146 such as touch-screen controller and/or a universal serial bus (“USB”) interface that couples user input to the system bus 1110, although other interfaces such as a parallel port, a game port or a wireless interface or a serial port may be used. The touch screen 1148 can be coupled to the system bus 1110 via a video interface 1150, such as a video adapter to receive image data or image information for display via the touch screen 1148. Although not shown, the processor-based device 1104 can include other output devices, such as speakers, vibrator, haptic actuator, etc.

The processor-based device 104 operates in a networked environment using one or more of the logical connections to communicate with one or more remote computers, servers and/or devices via one or more communications channels, for example, one or more networks 1114a, 1114b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1104 may include one or more wired or wireless communications interfaces 1114a, 1114b (e.g., cellular radios, WI-FI radios, Bluetooth radios) for establishing communications over the network, for instance the Internet 1114a or cellular network.

In a networked environment, program modules, application programs, or data, or portions thereof, can be stored in a server computing system (not shown). Those skilled in the relevant art will recognize that the network connections shown in FIG. 11 are only some examples of ways of establishing communications between computers, and other connections may be used, including wirelessly.

For convenience, the processor(s) 1106, system memory 1108, network and communications interfaces 1114a, 114b are illustrated as communicably coupled to each other via the system bus 1110, thereby providing connectivity between the above-described components. In alternative embodiments of the processor-based device 1104, the above-described components may be communicably coupled in a different manner than illustrated in FIG. 11. For example, one or more of the above-described components may be directly coupled to other components, or may be coupled to each other, via intermediary components (not shown). In some embodiments, system bus 1110 is omitted and the components are coupled directly to each other using suitable connections.

FIG. 12 shows a method 1200 executable by one or more processors to implement the various user interfaces described herein.

The method 1200 of starts at 1202, for example in response to a powering up or ON of a processor-based device, on receipt of a user input (e.g., touch of a touch-screen display via a finger or stylus, or operation of a computer mouse or trackball or the like), or in response to an invocation by a calling routine.

At 1204, the at least one processor determines whether a start of a user interaction is detected. For example, the at least one processor determines whether a selection of an object representation as part of a drag user interaction or a drag and drop user interaction has occurred. Such can include receiving signals from a touch-screen controller or routine.

At 1206, the at least one processor determines whether a pointer (e.g., finger, stylus, cursor) is positioned in a central area. If the pointer is positioned in the central area, at 1208 the at least one processor causes the object representation to move in synchronization with movement of the pointer, i.e., at the same speed and in the same direction as the pointer.

If the user interface element includes a top margin, at 1210 the at least one processor determines whether the pointer is in the top margin. If the at least one processor determines that the pointer is in the top margin, at 1212 the at least one processor determines whether an extremity of an object representation has been reached. For example, the at least one processor may determine that an image has been panned to an upper-most edge or boundary of the image, or that a list of values has been presented to a lowest-most value. If the extremity of the object representation has been reached, at 1214 the at least one processor halts movement of the object representation in a given direction, for example preventing further upward panning, or further decrementing of values. If on the other hand the extremity of the object representation has not been reached, at 1216 the at least one processor moves the object representation (e.g., pans up/moves view of image relatively downward or decrement values) at speed which is a function of a position of the pointer in the top margin relative to the central area. Thus, a speed can increase nonlinearly, for instance getting faster as the pointer moves in the top margin relatively further from the central area.

At 1218, the at least processor determines if an end of the user interaction has been detected. For example, the at least processor may determine whether the user has deselected the object representation in a drag operation or interaction or in a drag and drop operation or interaction.

If the user interface element includes a bottom margin, at 1220 the at least one processor determines whether the pointer is in the bottom margin. If the at least one processor determines that the pointer is in the bottom margin, at 1222 the at least one processor determines whether an extremity of an object representation has been reached. For example, the at least one processor may determine that an image has been panned to a bottom -most edge or boundary of the image, or that a list of values has been presented to a highest-most value. If the extremity of the object representation has been reached, at 1224 the at least one processor halts movement of the object representation in a given direction, for example preventing further downward panning, or further incrementing of values. If on the other hand the extremity of the object representation has not been reached, at 1226 the at least one processor moves the object representation (e.g., pans down/moves view of image relatively upward or increment values) at speed which is a function of a position of the pointer in the bottom margin relative to the central area. Thus, a speed can increase nonlinearly, for instance getting faster as the pointer moves in the bottom margin relatively further from the central area.

At 1228, the at least processor determines if an end of the user interaction has been detected. For example, the at least processor may determine whether the user has deselected the object representation in a drag operation or interaction or in a drag and drop operation or interaction.

If the user interface element includes a left margin, at 1230 the at least one processor determines whether the pointer is in the left margin. If the at least one processor determines that the pointer is in the left margin, at 1232 the at least one processor determines whether an extremity of an object representation has been reached. For example, the at least one processor may determine that an image has been panned to a right-most edge or boundary of the image, or that a list of values has been presented to a lowest-most value. If the extremity of the object representation has been reached, at 1234 the at least one processor halts movement of the object representation in a given direction, for example preventing further leftward panning, or further decrementing of values. If on the other hand the extremity of the object representation has not been reached, at 1236 the at least one processor moves the object representation (e.g., pans left/moves view of image relatively rightward or decrement values) at speed which is a function of a position of the pointer in the left margin relative to the central area. Thus, a speed can increase nonlinearly, for instance getting faster as the pointer moves in the left margin relatively further from the central area.

At 1238, the at least processor determines if an end of the user interaction has been detected. For example, the at least processor may determine whether the user has deselected the object representation in a drag operation or interaction or in a drag and drop operation or interaction.

If the user interface element includes a right margin, at 1240 the at least one processor determines whether the pointer is in the right margin. If the at least one processor determines that the pointer is in the right margin, at 1242 the at least one processor determines whether an extremity of an object representation has been reached. For example, the at least one processor may determine that an image has been panned to a left-most edge or boundary of the image, or that a list of values has been presented to a highest-most value. If the extremity of the object representation has been reached, at 1244 the at least one processor halts movement of the object representation in a given direction, for example preventing further rightward panning, or further incrementing of values. If on the other hand the extremity of the object representation has not been reached, at 1246 the at least one processor moves the object representation (e.g., pans right/moves view of image relatively leftward or increment values) at speed which is a function of a position of the pointer in the right margin relative to the central area. Thus, a speed can increase nonlinearly, for instance getting faster as the pointer moves in the right margin relatively further from the central area.

At 1248, the at least processor determines if an end of the user interaction has been detected. For example, the at least processor may determine whether the user has deselected the object representation in a drag operation or interaction or in a drag and drop operation or interaction.

The method 1200 may terminate at 1250, for example on detecting an end of the user interaction at 1218, 1228, 1238, 1248. The method 1200 may terminate until invoked again. Alternatively, the method 1200 may operate continually, for example as a thread on a multi-threaded processor.

While generally discussed with two or four margins, various implementations can include any number of margins. For example, five margins could be arranged in a pentagram about a central area or portion.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other processor-based devices and/or displays associated with processor-based devices, example touch-sensitive or touch-responsive displays of portable processor-based devices, not necessarily the exemplary processor-based devices generally described above.

For instance, the foregoing detailed description has set forth various embodiments of the systems, devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more processors, for instance one or more Application Specific Integrated Circuits (ASICs). However, those skilled in the art will recognize that the embodiments disclosed herein, in whole or in part, can be equivalently implemented in standard or generic integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units (CPUs), graphical processing units (GPUs), programmable gate arrays (PGAs), programmed logic controllers (PLCs)), as firmware, or as virtually any combination thereof, and that designing the circuitry and/or writing the code for the software and or firmware would be well within the skill of one of ordinary skill in the art in light of the teachings of this disclosure. As used herein and in the claims, the terms processor or processors refer to hardware circuitry, for example ASICs, microprocessors, CPUs, GPUs, PGAs, PLCs, and other microcontrollers.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any hardware that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CD-ROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
at least one processor;
at least one processor-readable medium, communicatively coupled to the at least one processor, and that stores at least one of processor-executable instructions or data, which when executed by the at least one processor causes the at least one processor to:
cause a presentation of a graphical representation of a user interface element comprising a first region with at least one pannable or scrollable element, the first region having a central portion and at least a first margin, the first margin disposed relatively outwardly of the central portion;
in response to a first drag operation in the central region, cause a number of updates to the presentation of the first region to display the at least one pannable or scrollable element as moving at a first rate; and
in response to a second drag operation in the first margin, cause a number of updates to the presentation of the first region to display the at least one pannable or scrollable element as moving at a second rate, the second rate faster than the first rate.

2. The system of claim 1 wherein, the second rate is variable and is based at least in part on a position of a pointer in the first margin.

3. The system of claim 1 wherein, when executed by the at least one processor, the instructions or data causes the at least one processor to: cause the number of updates to the presentation of the first region to display the at least one pannable or scrollable element as moving at the first rate which matches a rate of movement of a pointer that executes the first drag operation.

4. The system of claim 1 wherein, when executed by the at least one processor, the instructions or data causes the at least one processor to: cause the number of updates to the presentation of the first region to display the at least one pannable or scrollable element as moving at the second rate which varies based on a relative position of a pointer in the first margin with respect to the central portion.

5. The system of claim 1 wherein, when executed by the at least one processor, the instructions or data causes the at least one processor to: cause presentation of at least one visual effect that delineates at least the first margin from the central portion via a visually central portion perceptible boundary.

6. The system of claim 1 wherein, when executed by the at least one processor, the instructions or data causes the at least one processor to: cause presentation of at least one visual effect that delineates the first region of the user interface element from other portions of a window in which the user interface element is presented, via a visually perceptible user interface element boundary.

7. The system of claim 1 wherein, when executed by the at least one processor, the instructions or data causes the at least one processor further to:
in response to the first drag and drop operation in the central region, cause a number of updates to the presentation of the first region to display the at least one pannable or scrollable element as not moving; and
in response to the second drag and drop operation in the first margin, cause a number of updates to the presentation of the first region to display the at least one pannable or scrollable element as moving.

8. The system of claim 1 wherein, when executed by the at least one processor, the instructions or data causes the at least one processor to: cause the presentation of the first region as rectangular and having a second margin, the second margin diametrically opposed across the central portion from the first margin.

9. The system of claim 8 wherein, when executed by the at least one processor, the instructions or data causes the at least one processor to: cause the presentation of the first region having a third margin and a fourth margin, the fourth margin diametrically opposed across the central portion from the third margin, the first margin which extends along a first edge of the rectangular first region, the second margin which extends along a second edge of the rectangular first region, the third margin which extends along a third edge of the rectangular first region, and the fourth margin which extends along a fourth edge of the rectangular first region, and in response to a third drag operation in the third or the fourth margins, and to cause a number of updates to the presentation of the first region to display the at least one pannable or scrollable element as moving at a third rate, the third rate faster than the first rate, and the third rate is variable and is based at least in part on a position of a pointer in the third or the fourth margins.

10. The system of claim 1 wherein, when executed by the at least one processor, the instructions or data causes the at least one processor to: cause the presentation of the first region as at least one of circular or elliptical.

11. The system of claim 1 wherein, when executed by the at least one processor, the instructions or data causes the at least one processor to: cause the presentation of the at least one pannable or scrollable element as a scrollable list, the list having at least one dimension larger than a corresponding dimension of the first region.

12. The system of claim 1 wherein, when executed by the at least one processor, the instructions or data causes the at least one processor to: cause the presentation of the at least one pannable or scrollable element as a pannable image, the pannable image having at least one dimension larger than a corresponding dimension of first region.

13. The system of claim 1 wherein, when executed by the at least one processor, the instructions or data causes the at least one processor to: cause the presentation of the at least one pannable or scrollable element as a scrollable array of a plurality of pages, the array having at least one dimension larger than a corresponding dimension of first region.

14. The system of claim 13 wherein, when at least one of the pages has a respective scrollable element, and the at least one processor scrolls the respective scrollable element at a speed that is based on a position of a pointer.

15. A method, comprising:
causing a presentation of a graphical representation of a user interface element comprising a first region with at least one pannable or scrollable element, the first region having a central portion and at least a first margin, the first margin disposed relatively outwardly of the central portion;
in response to a first drag operation in the central region, causing a number of updates to the presentation of the first region to display the at least one pannable or scrollable element as moving at a first rate; and
in response to a second drag operation in the first margin, causing a number of updates to the presentation of the first region to display the at least one pannable or scrollable element as moving at a second rate, the second rate faster than the first rate.

16. The method of claim 15 wherein causing the number of updates to the presentation of the first region to display the at least one pannable or scrollable element as moving at a first rate includes causing the number of updates to the presentation of the first region to display the at least one pannable or scrollable element as moving at the first rate which matches a rate of movement of a pointer that executes the first drag operation.

17. The method of claim 15 wherein causing a number of updates to the presentation of the first region to display the at least one pannable or scrollable element as moving at a second rate which varies based on a relative position of a pointer in the first margin with respect to the central portion.

18. The method of claim 15, further comprising:
in response to a first drag and drop operation in the central region, causing a number of updates to the presentation of the first region to display the at least one pannable or scrollable element as not moving; and
in response to a second drag and drop operation in the first margin, causing a number of updates to the presentation of the first region to display the at least one pannable or scrollable element as moving.

19. The method of claim 15 wherein causing a presentation of a graphical representation of a user interface element includes causing the presentation of the graphical representation of the user interface element having a second margin, a third margin, and a fourth margin, the second margin diametrically opposed across the central portion from the first margin, the fourth margin diametrically opposed across the central portion from the third margin and to cause a number of updates to the presentation of the first region to display the at least one pannable or scrollable element as moving at a third rate, the third rate faster than the first rate, and the third rate variable and based at least in part on a position of a pointer in the second, the third or the fourth margins.

20. The method of claim 15 wherein, when executed by the at least one processor, the instructions or data causes the at least one processor to: cause the presentation of the at least one pannable or scrollable element as a scrollable array of a plurality of pages, the array having at least one dimension larger than a corresponding dimension of first region and when at least one of the pages has a respective scrollable element, and the at least one processor scrolls the respective scrollable element at a speed that is based on a position of a pointer.
